(19) United States
(12) Patent Application Publication
(10) Pub. No.: US 2026/0264182 A1
(43) Pub. Date: Sep. 10, 2026

(54) FITTING METHOD AND FITTING DEVICE

(71) Applicant: DAIFUKU CO., LTD., Osaka (JP)

(72) Inventors: Kaname FUJIMORI, Hino-cho (JP); Hiroshi OKAZAKI, Hino-cho (JP)

(73) Assignee: DAIFUKU CO., LTD., Osaka (JP)

(21) Appl. No.: 19/545,718

(22) Filed: Feb. 20, 2026

(30) Foreign Application Priority Data
Mar. 5, 2025 (JP) 2025-034936

(51) Int. Cl. B23P 19/04

(52) U.S. Cl. CPC B23P 19/04

(57) ABSTRACT

The present disclosure facilitates fitting of a fitting part to a fitted part even in a case where an axial center shift occurs. A fitting method of the present disclosure includes a movement step of, by controlling a movement section that moves a nut runner provided with a socket to be fitted to a bolt, moving the socket closer to the bolt while moving the nut runner along an orthogonal plane orthogonal to the axial center of the socket with the axial center set as the center of the movement.

This Nonprovisional application claims priority under 35 U.S.C. § 119 on Patent Application No. 2025-034936 filed in Japan on Mar. 5, 2025, the entire contents of which are hereby incorporated by reference.

### TECHNICAL FIELD

The present disclosure relates to a technology that fits a fitting part to a fitted part.

### BACKGROUND ART

Conventionally, for example, in manufacturing lines for automobiles, after a coating step has been carried out with doors attached to vehicle bodies, a door detaching step of temporarily detaching the doors from the vehicle bodies is carried out in order to assemble components to the vehicle bodies or the like. In this door detaching step, a door detaching device is used which detaches a door from a vehicle body by fitting a socket to a bolt that fixes the door to the vehicle body and loosening the bolt.

In relation to such a fitting technology for fasteners, for example, Patent Literature 1 discloses a fastening method for moving a male screw along its axial direction and coupling the male screw with a female screw.

### CITATION LIST

### Patent Literature [Patent Literature 1]

Japanese Patent Application Publication Tokukai No. 2002-331428

### SUMMARY OF INVENTION

### Technical Problem

However, with a configuration that moves a male screw along its axial direction as in the conventional technology, in a case where a positional shift occurs between the male screw and the female screw, the positional shift cannot be absorbed, and thus it has not been easy to couple the two screws.

An aspect of the present disclosure has been made in light of the foregoing conventional problem, and it is an object thereof to provide a fitting method and a fitting device that enable easy fitting of a fitting part to a fitted part even in a case where an axial center shift (positional shift) occurs between the fitting part and the fitted part.

### Solution to Problem

In order to solve the foregoing problem, a fitting method in accordance with an aspect of the present disclosure includes: a movement step of, by controlling a movement section that moves a fastening and loosening member provided with a fitting part to be fitted to a fitted part which is a fitting target, moving the fitting part closer to the fitted part while moving the fastening and loosening member along an orthogonal plane orthogonal to an axial center of the fitting part; and a stop step of stopping movement of the fastening and loosening member along the orthogonal plane in a case where the fitting part is fitted to the fitted part.

In order to solve the foregoing problem, a fitting device in accordance with an aspect of the present disclosure includes: a fastening and loosening member provided with a fitting part to be fitted to a fitted part which is a fitting target; and a movement section that moves the fastening and loosening member, the movement section being configured to move the fitting part closer to the fitted part while moving the fastening and loosening member along an orthogonal plane orthogonal to an axial center of the fitting part and stop movement of the fastening and loosening member along the orthogonal plane in a case where the fitting part is fitted to the fitted part.

### Advantageous Effects of Invention

An aspect of the present disclosure makes it possible to provide a fitting method and a fitting device that enable easy fitting of a fitting part to a fitted part even in a case where an axial center shift occurs between the fitting part and the fitted part.

### BRIEF DESCRIPTION OF DRAWINGS

FIG. 1 is a plan view illustrating facilities including a door detaching system in accordance with an embodiment.

FIG. 2 is a perspective view illustrating main components of a door detaching device included in the door detaching system.

FIG. 3 is an exploded view illustrating the door detaching device.

FIG. 4 is a view schematically illustrating a state in which a door is gripped by the door detaching device.

FIG. 5 is an enlarged view of a part enclosed by the dashed line in FIG. 4.

FIG. 6 is a functional block diagram illustrating main components of a control device that controls the door detaching system.

FIG. 7 is a schematic view for explaining a fitting operation of fitting a socket to a bolt fastened to a door.

FIG. 8 is a schematic view for explaining movement along an orthogonal plane of a nut runner included in the door detaching device.

FIG. 9 is a flowchart illustrating a flow of a fitting operation of fitting a socket to a bolt.

FIG. 10 is a view schematically illustrating a state in which the nut runner stops at an approach point.

FIG. 11 is a schematic view for explaining movement along an orthogonal plane of the nut runner.

FIG. 12 is a schematic view for explaining the order of movements along an orthogonal plane of the nut runner.

### DESCRIPTION OF EMBODIMENTS

The following description will discuss an embodiment of the present disclosure. In the present embodiment, a fitting device in accordance with the present disclosure will be described taking as an example a case where the fitting device is applied to a door detaching system used in a manufacturing line for an automobile. Note that the following will describe one example of a fitting device in accordance with the present disclosure, and the technical scope of the present disclosure is not limited to the examples illustrated in the drawings.

### Overview of Door Detaching System

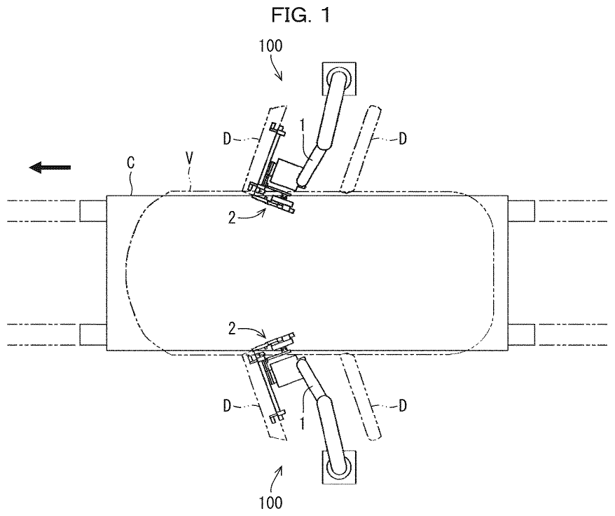

First, the following will describe an overview of a door detaching system 100 in accordance with the present embodiment. FIG. 1 is a plan view illustrating facilities including the door detaching systems 100 in accordance with the present embodiment. As illustrated in FIG. 1, the door detaching systems 100 are each a device for detaching a door D attached to a vehicle body V, for example, in a manufacturing line for an automobile. The door detaching systems 100 are disposed on both left and right sides of a conveyance path of the vehicle body V conveyed by a conveyance device C.

The door detaching system 100 in accordance with the present embodiment includes a manipulator 1 and a door detaching device 2. The manipulator 1 is a robot arm having a plurality of joints. The door detaching device 2 is attached to the tip end side of the manipulator 1. The door detaching device 2 may be attached to, for example, a turning support unit constituting a wrist part on a tip end side of the manipulator 1. The position, orientation, and the like of the door detaching device 2 are changed by operation of the manipulator 1.

When the door detaching system 100 detaches the door D from the vehicle body V, the door detaching device 2 that has been moved closer to the door D by operation of the manipulator 1 grips the door D and detaches the door D from the vehicle body V. Then, the door detaching system 100 moves the door D to a predetermined location by operation of the manipulator 1 in a state in which the door D detached from the vehicle body V is gripped by the door detaching device 2.

### Configuration of Door Detaching Device

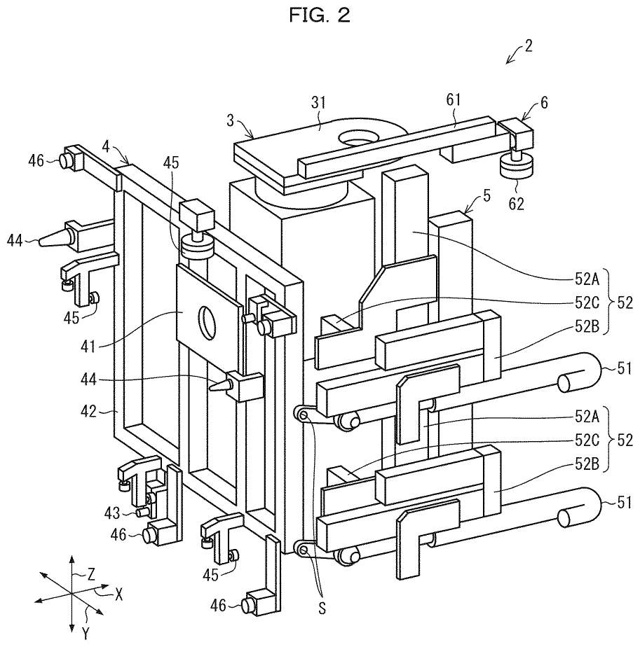

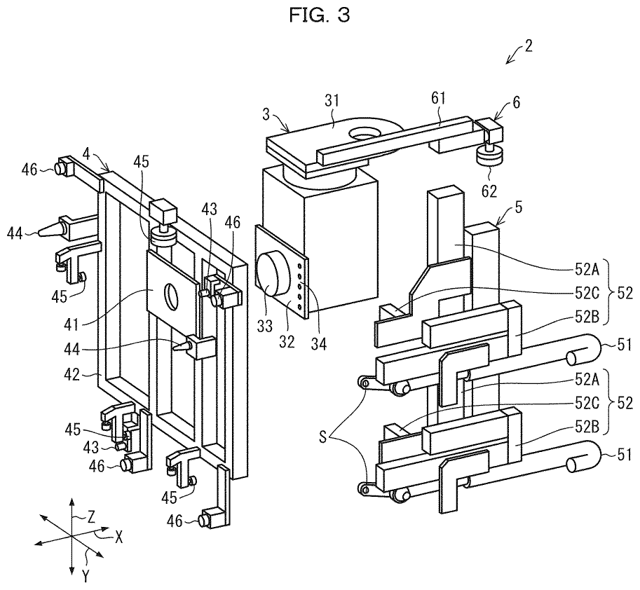

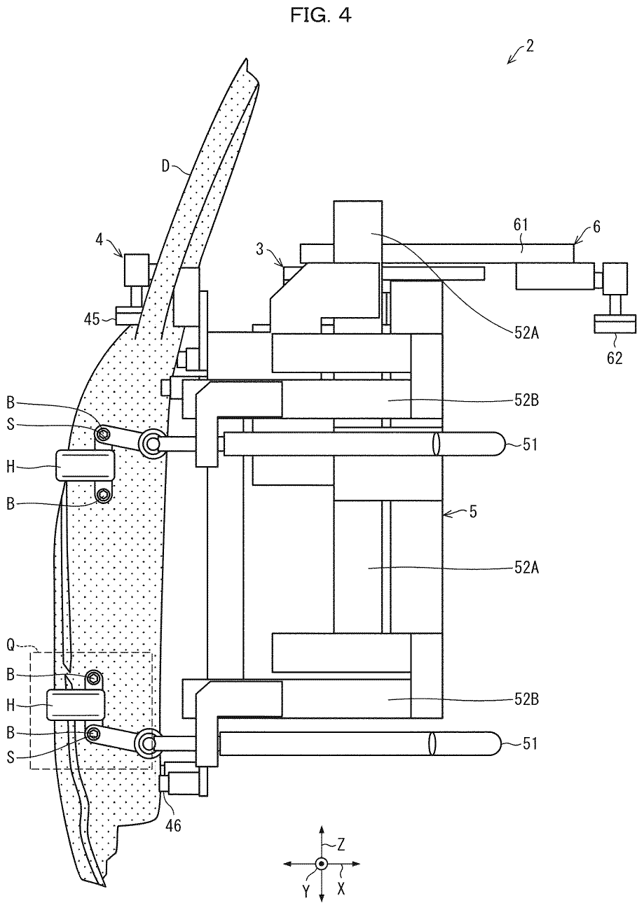

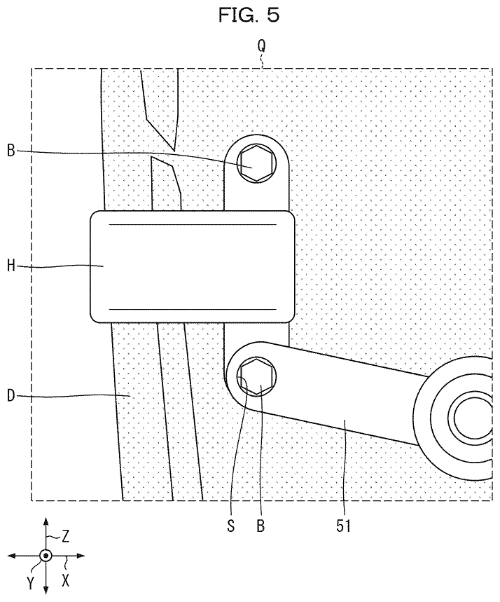

Next, the following will describe the configuration of each door detaching device 2 included in the door detaching system 100 in accordance with the present embodiment. FIG. 2 is a perspective view illustrating main components of the door detaching device 2 illustrated in FIG. 1. FIG. 3 is an exploded view of the door detaching device 2 illustrated in FIG. 2. FIG. 4 is a view schematically illustrating a state in which the door detaching device 2 illustrated in FIG. 2 grips the door D. FIG. 5 is an enlarged view of a part Q enclosed in the dashed line in FIG. 4.

As illustrated in FIGS. 2 and 3, the door detaching device 2 includes a floating unit 3 connected to the manipulator 1, a gripping unit 4 that grips the door D, a nut runner unit (fitting device) 5 that has sockets S, and a door opening arm 6 that opens the door D.

The door detaching device 2 is configured so that the floating unit 3 is supported by the manipulator 1. Further, the door detaching device 2 is configured so that the gripping unit 4, the nut runner unit 5, and the door opening arm 6 are supported by the floating unit 3.

Note that in the following description, in the axial directions in a three-dimensional orthogonal coordinate system composed of an X-axis, a Y-axis, and a Z-axis, the horizontal direction in which the floating unit 3 and the gripping unit 4 are arranged may be referred to as an X direction, and the horizontal direction in which the floating unit 3 and the nut runner unit 5 are arranged may be referred to as a Y direction. Further, the vertical direction orthogonal to the X direction and the Y direction may be referred to as a Z direction.

### Floating Unit

The floating unit 3 is configured to provide floating support to the gripping unit 4, the nut runner unit 5, and the door opening arm 6. Via this floating unit 3, the manipulator 1 provides three-dimensional floating support to the gripping unit 4, the nut runner unit 5, and the door opening arm 6.

The floating unit 3 has a plate-shaped arm connection section 31 to which the manipulator 1 is connected. The arm connection section 31 is provided on an upper side of the floating unit 3 in the Z direction. To this arm connection section 31, the door opening arm 6 is connected.

The floating unit 3 further includes a plate-shaped unit support section 32 supporting the gripping unit 4 and the nut runner unit 5. The unit support section 32 is provided on one side of the floating unit 3 in the X direction. A first connection section 33 is provided at a center part of the unit support section 32. To this first connection section 33, the gripping unit 4 is connected. A second connection section 34 is provided on one side of the unit support section 32 in the Y direction. To this second connection section 34, the nut runner unit 5 is connected.

### Gripping Unit

The gripping unit 4 is a jig for gripping the door D. The gripping unit 4 moves to a predetermined position with respect to the door D by operation of the manipulator 1, and grips the door D. The gripping unit 4 includes a plate-shaped connection plate 41, a support frame 42, proximity sensors 43, reference pins 44, and gripping sections 45.

The connection plate 41 is connected to the first connection section 33 of the floating unit 3 via, for example, bolts. The plurality of proximity sensors 43, the plurality of reference pins 44, and the plurality of gripping sections 45 are provided on the frame-shaped support frame 42.

The proximity sensors 43 are each a sensor that detects the approach of the door D. The reference pins 44 are each a guide for positioning the gripping unit 4 with respect to the door D. The gripping sections 45 are each a mechanism for gripping the door D. The gripping section 45 may be, for example, a clamping mechanism including an air cylinder and a clamp that expands and contracts by the air cylinder.

Further, the gripping unit 4 may have, as a clamping mechanism, a plurality of receiving sections 46 provided on the support frame 42. The receiving sections 46 are configured to receive the inner panel of the door D when the door D is gripped.

### Nut Runner Unit

The nut runner unit 5 includes paired nut runners (fastening and loosening members) 51. The nut runners 51 are each an electric nut runner (electric torque wrench) that uses a motor as a drive source. The nut runner 51 is configured in a linear shape as a whole. Each of the nut runners 51 has, at its tip end part, a socket (fitting part) S that is fitted to (engaged with) a bolt (fitting target, fitted part) B that fixes the door D to the vehicle body V.

The nut runners 51 are disposed in upper and lower positions along the X direction so as to be spaced from each other by a predetermined distance in the Z direction. As illustrated in FIGS. 4 and 5, the upper and lower nut runners 51 correspond to the hinges H provided in two upper and lower positions between the vehicle body V and the door D, and are used to unfasten the bolts B. The nut runners 51 are each configured to detach the bolt B from the vehicle body V by, for example, rotationally driving the socket S with use of a motor in a state in which the socket S is fitted to the bolt B.

The nut runner unit 5 includes movement sections 52 that move the nut runners 51. Each of the movement sections 52 is provided for a corresponding one of the nut runners 51 so as to enable individual movement of the nut runner 51.

The movement section 52 includes paired first linear actuator 52A and second linear actuator 52B that move the nut runner 51 in the Z direction and the X direction that are orthogonal to each other. The first linear actuator 52A and the second linear actuator 52B are each constituted by, for example, an electric cylinder (Robo cylinder).

The movement section 52 further includes a third linear actuator 52C that moves the nut runner 51 in the Y direction. The third linear actuator 52C is constituted by, for example, an air cylinder. The third linear actuator 52C may be, for example, a measuring cylinder capable of measuring a movement distance and outputting a measured value of the movement distance.

The first linear actuator 52A is disposed so that its axial direction is parallel to the Z direction, and causes the nut runner 51 to reciprocate in the Z direction. The second linear actuator 52B is disposed so that its axial direction is parallel to the X direction, and causes the nut runner 51 to reciprocate in the X direction. The third linear actuator 52C is disposed so that its axial direction is parallel to the Y direction, and causes the nut runner 51 to reciprocate in the Y direction.

The nut runner unit 5 is configured to be able to move the nut runner 51 in the XYZ directions to change the position of the nut runner 51 by controlling each of the first linear actuator 52A, the second linear actuator 52B, and the third linear actuator 52C.

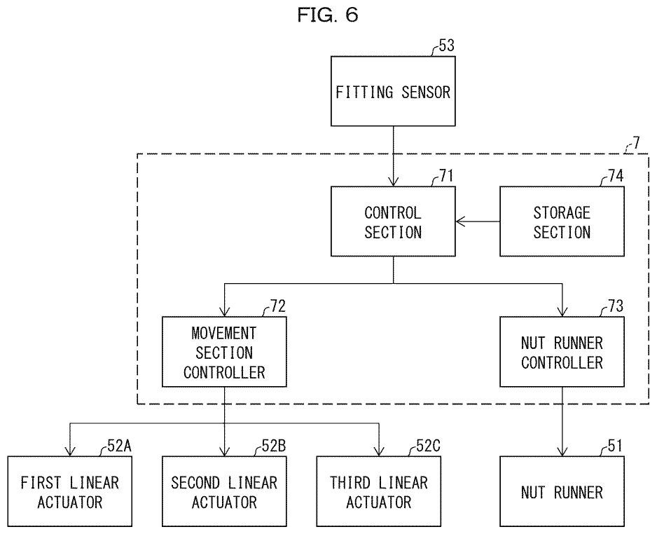

The nut runner unit 5 further includes a fitting sensor 53 that detects that the socket S has been fitted to the bolt B (see FIG. 6). This fitting sensor 53 is configured to detect that the socket S has been fitted to the bolt B by detecting a change in a rotational torque of the socket S, as will be described later.

### Door Opening Arm

The door opening arm 6 is a mechanism that brings the door D attached to the vehicle body V from a closed state to an open state. The door opening arm 6 includes a linearly shaped frame body section 61 constituted by, for example, an aluminum frame, and a door locking section 62 provided to the frame body section 61.

One end of the frame body section 61 is supported by the arm connection section 31 of the floating unit 3, and to the other end opposite to the one end, the door locking section 62 is provided. The door opening arm 6 is configured to open the door D by locking the door locking section 62 onto the door D in a closed state by operation of the manipulator 1, and pulling the door D with use of the door opening arm 6 by a door opening operation of the manipulator 1.

### Configuration of Control Device

Next, the following will describe the configuration of a control device 7 that controls the door detaching system 100. FIG. 6 is a functional block diagram illustrating main components of the control device 7 that controls the door detaching system 100. Note that FIG. 6 illustrates only a controlling system, for the nut runner unit 5, of the control device 7.

As illustrated in FIG. 6, the control device 7 includes a control section 71, a movement section controller 72, a nut runner controller 73, and a storage section 74.

The control section 71 controls operations of the components of the door detaching system 100, including the nut runner unit 5. The control section 71 is constituted by, for example, a programmable logic controller (PLC). The control section 71 reads a preprogrammed control sequence from the storage section 74, and controls the operation of the nut runner unit 5 in accordance with the control sequence. Further, the control section 71 controls the operation of the nut runner unit 5 on the basis of a detection signal from the fitting sensor 53.

The movement section controller 72 controls the movement sections 52 on the basis of a control signal outputted from the control section 71. For example, the movement section controller 72 controls the first linear actuators 52A, the second linear actuators 52B, and the third linear actuators 52C to move the nut runners 51 in the XYZ directions.

The nut runner controller 73 controls the nut runners 51 on the basis of a control signal outputted from the control section 71. For example, the nut runner controller 73 controls the nut runners 51 to control rotational driving, rotational speeds, and the like of the sockets S.

The storage section 74 stores various data. The storage section 74 stores a program for a control sequence of the door detaching system 100. As the storage section 74, for example, a random access memory, a flash memory, a hard disk drive, or the like can be used.

### Fitting Operation of Nut Runner Unit

Next, the following will describe a fitting operation of fitting the socket S to the bolt B by the nut runner unit 5. As described above, in a manufacturing line for an automobile, after a coating step, a door detaching step of temporarily detaching the door D from the vehicle body V is carried out. In this door detaching step, the nut runner unit 5 is configured to fit the socket S to the bolt B that fixes the door D to the vehicle body V and loosen the bolt B to detach it. In such a fitting operation of fitting the socket S to the bolt B, in a case where an axial center shift (positional shift) occurs between the socket S and the bolt B, it has not been easy to fit the socket S to the bolt B.

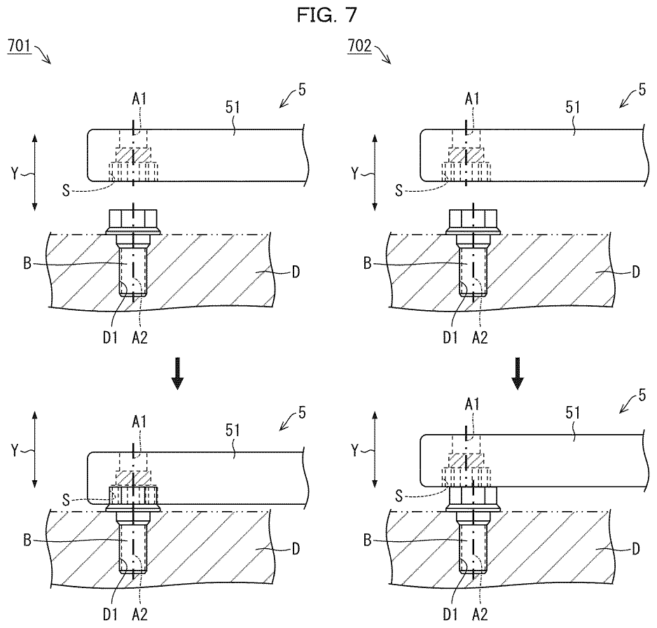

FIG. 7 is a schematic view for explaining the fitting operation of fitting the socket S to the bolt B fastened to the door D. Reference numeral 701 of FIG. 7 indicates a case where the axial center A1 of the socket S and the axial center A2 of the bolt B align, and reference numeral 702 of FIG. 7 indicates a case where an axial center shift is occurring between the axial center A1 of the socket S and the axial center A2 of the bolt B. In FIG. 7, illustration of the hinges H is omitted.

As illustrated in FIG. 7, the door D is provided with fastening holes D1 formed to be screwed with the bolts B, and into these fastening holes D1, the bolts B are fastened. In a case where, as indicated by reference numeral 701 of FIG. 7, the axial center A1 of the socket S and the axial center A2 of the bolt B align, that is, a case where no axial center shift is occurring between the axial center A1 of the socket S and the axial center A2 of the bolt B, movement of the nut runner 51 in the Y direction enables the socket S to be fitted to the bolt B.

In contrast, in a case where, as indicated by reference numeral 702 of FIG. 7, an axial center shift is occurring between the axial center A1 of the socket S and the axial center A2 of the bolt B, the socket S is not fitted to the head part of the bolt B even if the nut runner 51 is moved in the Y direction. It is thus impossible to fit the socket S to the bolt B.

Therefore, the nut runner unit 5 is configured so that the socket S is moved closer to the bolt B while moving the nut runner 51 in an XZ plane direction orthogonal to the Y direction in order to facilitate fitting of the socket S to the head part of the bolt B even in a case where an axial center shift occurs between the socket S and the bolt B.

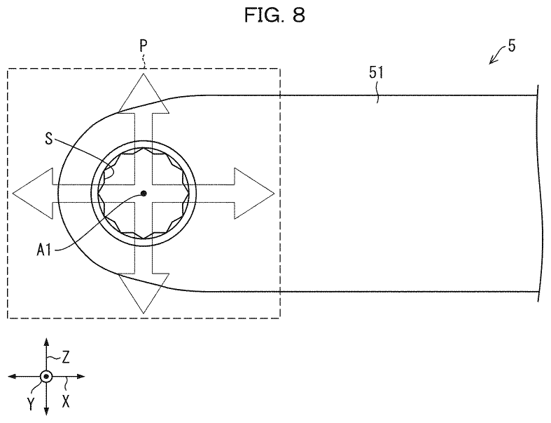

FIG. 8 is a schematic view for explaining movement along an orthogonal plane P of the nut runner 51. As illustrated in FIG. 8, when moving the socket S closer to the bolt B, the movement section controller 72 is configured to control the movement section 52 to slightly move (finely move, vibrate) the nut runner 51 with respect to the axial center A1 along the orthogonal plane (XZ plane) P orthogonal to the axial center A1 of the socket S.

Moving, as described above, the socket S closer to the bolt B while slightly moving the nut runner 51 along the orthogonal plane P enables absorption of an axial center shift between the socket S and the bolt B. Therefore, even in a case where an axial center shift occurs between the socket S and the bolt B, fitting of the socket S to the bolt B is facilitated.

### Flow of Fitting Operation

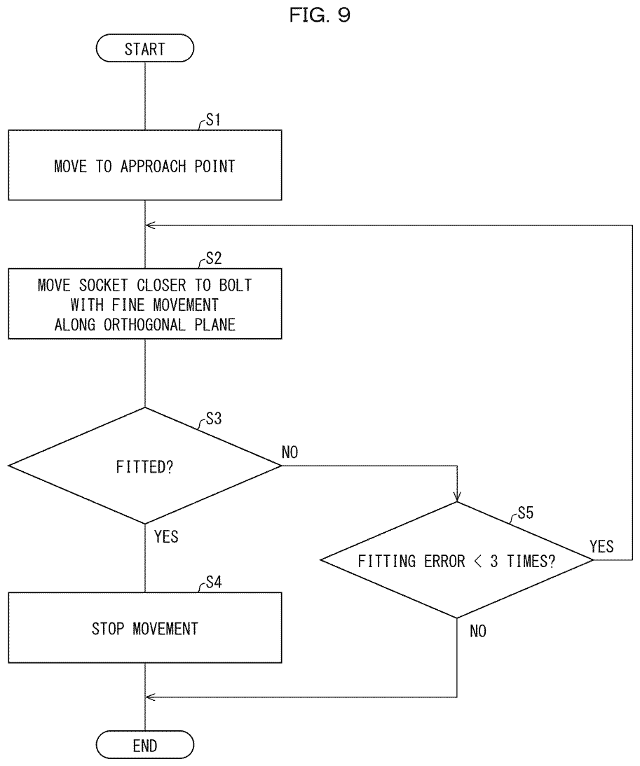

Next, the following will describe a flow of a fitting operation (fitting method) of the nut runner unit 5 for fitting the socket S to the bolt B. FIG. 9 is a flowchart illustrating a flow of a fitting operation of fitting the socket S to the bolt B. The flowchart of the fitting operation illustrated in FIG. 9 is carried out after a door gripping operation of gripping the door D by the gripping unit 4 (see FIG. 4). The fitting operation is carried out by control by the control section 71 over the movement section controller 72 and the nut runner controller 73.

After the gripping unit 4 has gripped the door D, the movement section controller 72 controls the movement section 52 to move the nut runner 51 from its original position (bolt chuck position) to the approach point (bolt detachment position) (step S1). The approach point is an approach start position where an approach movement of the socket S with respect to the bolt B in the Y direction is started in the following step S2. The movement section controller 72 controls, for example, the first linear actuator 52A and the second linear actuator 52B to move the nut runner 51 to the approach point.

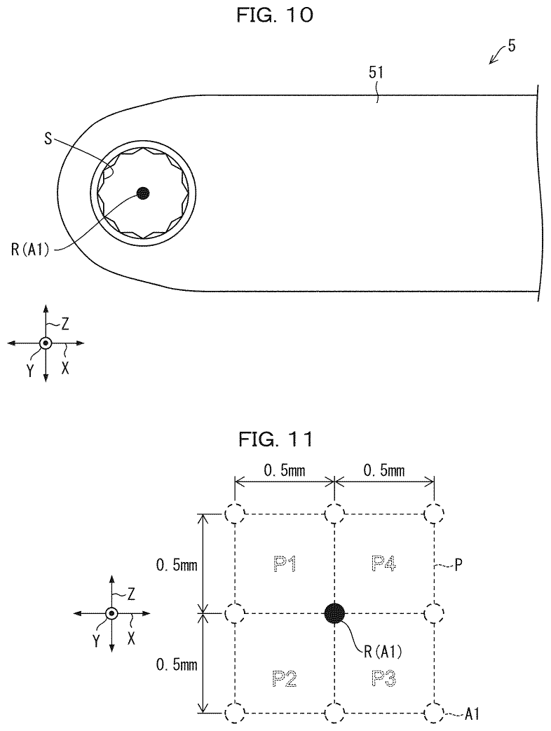

FIG. 10 is a view schematically illustrating a state in which the nut runner 51 stops at the approach point. As illustrated in FIG. 10, the nut runner 51 is disposed so that the axial center A1 of the socket S aligns with a reference point R taught in advance in a state in which the nut runner 51 stops at the approach point. The reference point R is an approximate position of the axial center A2 corresponding to the position of the axial center A2 of the bolt B.

Fitting of the socket S to the bolt B is facilitated by, as described above, aligning the axial center A1 of the socket S with the reference point R corresponding to the position of the axial center A2 of the bolt B, and then, in the following step S2, moving the socket S closer to the bolt B while moving the nut runner 51 along the orthogonal plane P.

In the present embodiment, the reference point R is taught in advance, and is stored beforehand in, for example, the storage section 74. Note, however, that the reference point R may not be stored beforehand in the storage section 74. For example, the reference point R may be acquired on the basis of data of an image of a location including the bolt B which has been captured with use of a camera or the like before or during operation of the door detaching system 100.

Next, the movement section controller 72 controls the movement sections 52 to move the socket S closer to the bolt B while moving the nut runner 51 along the orthogonal plane P (step S2: movement step). For example, the movement section controller 72 controls the first linear actuator 52A and the second linear actuator 52B to move the nut runner 51 along the orthogonal plane P with the reference point R set as the center of the movement. Further, the movement section controller 72 controls the third linear actuator 52C to move the nut runner 51 in the Y direction, thereby moving the socket S closer to the bolt B.

FIG. 11 is a schematic view for explaining movement along the orthogonal plane P of the nut runner 51. FIG. 11 illustrates a trajectory of the axial center A1 of the socket S along the orthogonal plane P of the movement of the nut runner 51.

As illustrated in FIG. 11, the first linear actuator 52A and the second linear actuator 52B move the nut runner 51 along the orthogonal plane (XZ plane) P orthogonal to the axial center A1 of the socket S with the reference point R (axial center A1) set as the center of the movement. This enables the nut runner 51 to move along the orthogonal plane P with use of a simple mechanism with two-axis linear motion, and enables the device configuration of the nut runner unit 5 to be simplified.

The direction in which the nut runner 51 moves along the orthogonal plane P is not particularly limited. For example, the nut runner 51 may be moved along the orthogonal plane P so that the axial center A1 of the socket S draws a circular trajectory about the reference point R. Further, the nut runner 51 may be moved along the orthogonal plane P so that the axial center A1 of the socket S draws a trajectory that has rotational symmetry about the reference point R.

Note, however, that it is not essential to move the socket S so as to make the movement symmetrical (rotation-symmetrical) about the reference point R, and it is sufficient to move the socket S so as to enable absorption of an axial center shift that may occur between the socket S and the bolt B.

Further, the movement range (movement distance from the reference point R) of the nut runner 51 along the orthogonal plane P is also not particularly limited. It is sufficient to set the movement range of the nut runner 51 so as to enable absorption of an axial center shift that may occur between the socket S and the bolt B.

For example, as illustrated in FIG. 11 as an example, the movement range of the nut runner 51 may be set so that the axial center A1 of the socket S moves within a range of ±0.5 mm in each of the X direction and the Z direction with the reference point R set as the center of the movement. In this case, the nut runner 51 may be moved along the orthogonal plane P so that the axial center A1 of the socket S draws four squares P1 to P4 which are formed by rotating a square with a side of 0.5 mm and having a corner at the reference point R by 90 degrees each rotation about the reference point R.

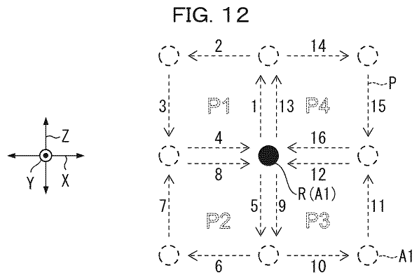

FIG. 12 is a schematic view for explaining the order of movements along the orthogonal plane P of the nut runner 51 illustrated in FIG. 11. As illustrated in FIG. 12, in a case where the socket S is moved so as to draw the four squares P1 to P4 each having a corner at the reference point R, the axial center A1 of the socket S may be moved, for example, in the order of the numbers attached to the arrows in the drawing. Specifically, the nut runner 51 may be moved along the orthogonal plane P so that the axial center A1 of the socket S continuously draws the four squares P1 to P4, which have 90-degree rotational symmetry about the reference point R, in a clockwise or counterclockwise direction.

Moving, as described above, the socket S so as to be rotation-symmetrical about the reference point R enables suitable absorption of the axial center shift between the socket S and the bolt B.

Further, in step S2, the nut runner 51 may rotate the socket S at a low speed (for example, 30 rpm) about its axial center. This facilitates fitting of the socket S to the bolt B. Further, in the following step S3, fitting between the socket S and the bolt B can be detected on the basis of a change in the rotational torque of the socket S which occurs when the socket S is fitted to the bolt B.

For example, when the axial centers of the socket S and the bolt B align, but positions where the socket S and the bolt B are fitted to each other (for example, the positions of the corner of the socket S and the corner of the head part of the bolt B) do not align, the socket S may not be able to be fitted to the bolt B. Even in this case, by rotating the socket S at a low speed about its axial center, fitting of the socket S to the bolt B is facilitated.

Next, after step S2 has started, the control section 71 determines whether or not the socket S has been fitted to the bolt B (step S3: detection step). For example, the control section 71 determines whether the rotational torque of the socket S has reached a fitting torque threshold on the basis of an output signal from the fitting sensor 53. The fitting torque threshold is a threshold for determining whether or not the socket S has been fitted to the bolt B, and is stored beforehand in the storage section 74.

For example, in a case where a rotational torque equal to or greater than the fitting torque threshold is not detected by the fitting sensor 53 for a predetermined time period from start of the approach movement of the socket S, the control section 71 determines that the socket S is not fitted to the bolt B, and a fitting error has occurred (NO in step S3).

In a case where it is determined that a fitting error has occurred, the control section 71 determines whether or not the number of times of consecutive occurrences of the fitting error is less than a predetermined number of times (three times in the present embodiment) (step S5). In a case where the number of times of consecutive occurrences of the fitting error is less than three times (YES in step S5), the control section 71 controls the movement section 52 to return the nut runner 51 to the approach start position, and carries out step S2 and step S3 again. On the other hand, in a case where the fitting error has occurred three consecutive times (NO in step S5), the control section 71 determines that an abnormality has occurred in the door detaching system 100. In this case, the control section 71 brings the door detaching system 100 to an emergency stop to end the fitting operation, and outputs an abnormality signal indicating that an abnormality has occurred.

In contrast, in a case where a rotational torque equal to or greater than the fitting torque threshold is detected by the fitting sensor 53, the control section 71 determines that the socket S has been fitted to the bolt B (YES in step S3). In this case, the control section 71 stops the movement of the nut runner 51 (step S4: stop step). For example, the movement section controller 72 controls the first linear actuator 52A and the second linear actuator 52B to stop the movement of the nut runner 51 along the orthogonal plane P. Further, the movement section controller 72 controls the third linear actuator 52C to stop the movement of the nut runner 51 in the Y direction. The control section 71 thus ends the fitting operation of fitting the socket S to the bolt B.

As such, in the fitting operation of the nut runner unit 5, the socket S is fitted to the bolt B while moving the nut runner 51 along the orthogonal plane P. Therefore, an axial center shift between the socket S and the bolt B is absorbed, thus facilitating fitting of the socket S to the bolt B.

Note that the control section 71 proceeds to a bolt loosening operation after the end of the above-described fitting operation. In this bolt loosening operation, the nut runner controller 73 controls the nut runner 51 to rotate the socket S about its axial center to loosen the bolt B, and detaches the bolt B fastened to the door D.

### Effects of Nut Runner Unit

As such, the nut runner unit 5 in accordance with the present embodiment includes the nut runners 51 provided with the sockets S to be fitted to the bolts B which are fitting targets, and the movement sections 52 that move the nut runners 51. Each of the movement sections 52 moves the socket S closer to the bolt B while moving the nut runner 51 along the orthogonal plane P orthogonal to the axial center A1 of the socket S. Further, the movement section 52 stops the movement of the nut runner 51 along the orthogonal plane P in a case where the socket S is fitted to the bolt B.

The nut runner unit 5 fits the socket S to the bolt B while moving the nut runner 51 along the orthogonal plane P to the axial center A1 of the socket S. This facilitates absorption of an axial center shift between the socket S and the bolt B. Therefore, according to the present embodiment, even in a case where an axial center shift occurs between the socket S and the bolt B, fitting of the socket S to the bolt B is facilitated.

Note that in the above-described embodiment, an example configuration is described in which the nut runner unit 5 is used to fit the socket S to the bolt B fastened into the fastening hole D1 of the door D. However, the nut runner unit 5 is also applicable to, for example, a case where the bolt B is fastened into the fastening hole D1 of the door D. In this case, for example, when moving the bolt (fitting part) B provided on the socket S closer to the fastening hole (fitted part) D1 of the door D, the bolt B may be fitted into the fastening hole D1 while moving the nut runner 51 along the orthogonal plane P. This facilitates fitting of the bolt B into the fastening hole D1, even in a case where an axial center shift occurs between the bolt B and the fastening hole D1.

Aspects of the present invention can also be expressed as follows:

A fitting method in accordance with Aspect 1 of the present disclosure includes: a movement step of, by controlling a movement section that moves a fastening and loosening member (nut runner 51) provided with a fitting part (socket S) to be fitted to a fitted part (bolt B) which is a fitting target, moving the fitting part closer to the fitted part while moving the fastening and loosening member along an orthogonal plane orthogonal to an axial center of the fitting part; and a stop step of stopping movement of the fastening and loosening member along the orthogonal plane in a case where the fitting part is fitted to the fitted part.

According to the above method, the fitting part is fitted to the fitted part while moving the fastening and loosening member along the orthogonal plane to the axial center of the fitting part. This facilitates absorption of an axial center shift between the fitting part and the fitted part. Therefore, according to the above method, even in a case where an axial center shift occurs between the fitting part and the fitted part, fitting of the fitting part to the fitted part is facilitated.

In a fitting method in accordance with Aspect 2 of the present disclosure, in Aspect 1 above, the movement section may include paired linear actuators that move the fastening and loosening member in two directions parallel to the orthogonal plane and orthogonal to each other, and in the movement step, the paired linear actuators may be controlled to move the fastening and loosening member along the orthogonal plane.

In the above method, the paired linear actuators that move the fastening and loosening member are controlled to move the fastening and loosening member along the orthogonal plane. Therefore, the above method enables the fastening and loosening member to move along the orthogonal plane with use of a simple mechanism with two-axis linear motion, and enables the device configuration to be simplified.

In a fitting method in accordance with Aspect 3 of the present disclosure, in Aspect 1 or 2 above, in the movement step, the movement section may move the fastening and loosening member along the orthogonal plane after aligning the axial center of the fitting part with a reference point corresponding to a position of an axial center of the fitted part.

According to the above method, because the movement section moves the fastening and loosening member along the orthogonal plane with a reference point corresponding to a position of an axial center of the fitted part set as the center of the movement, fitting of the fitting part to the fitted part is facilitated.

A fitting method in accordance with Aspect 4 of the present disclosure may, in any one of Aspects 1 to 3 above, further include a detection step of, after the movement step has started, detecting that the fitting part has been fitted to the fitted part.

According to the above method, by detecting in the detection step that the fitting part has been fitted to the fitted part, the movement of the fastening and loosening member along the orthogonal plane can be appropriately stopped in the stop step.

In a fitting method in accordance with Aspect 5 of the present disclosure, in Aspect 4 above, in the movement step, the fitting part may be moved closer to the fitted part while rotating the fitting part about the axial center of the fitting part, and in the detection step, a change in a rotational torque of the fitting part may be detected.

According to the above method, fitting of the fitting part to the fitted part is facilitated. Further, for example, fitting between the fitting part and the fitted part can be detected on the basis of a change in a rotational torque of the fitting part which occurs when the fitting part is fitted to the fitted part.

A fitting device in accordance with Aspect 6 of the present disclosure includes: a fastening and loosening member provided with a fitting part to be fitted to a fitted part which is a fitting target; and a movement section that moves the fastening and loosening member, the movement section being configured to move the fitting part closer to the fitted part while moving the fastening and loosening member along an orthogonal plane orthogonal to an axial center of the fitting part and stop movement of the fastening and loosening member along the orthogonal plane in a case where the fitting part is fitted to the fitted part.

In the above configuration, the fitting part is fitted to the fitted part while moving the fastening and loosening member along the orthogonal plane to the axial center of the fitting part. This facilitates absorption of an axial center shift between the fitting part and the fitted part. Therefore, according to the above configuration, even in a case where an axial center shift occurs between the fitting part and the fitted part, fitting of the fitting part to the fitted part is facilitated.

The present disclosure is not limited to the above-described embodiment, but can be altered by a skilled person in the art within the scope of the claims. The present disclosure also encompasses, in its technical scope, any embodiment derived by appropriately combining technical means disclosed in the embodiment.

### REFERENCE SIGNS LIST

1: Manipulator
2: Door detaching device
5: Nut runner unit (fitting device)
51: Nut runner (fastening and loosening member)
52: Movement section
52A: First linear actuator (movement section, linear actuator)
52B: Second linear actuator (movement section, linear actuator)
52C: Third linear actuator (movement section)
53: Fitting sensor
100: Door detaching system
A1: Axial center of socket
A2: Axial center of bolt
B: Bolt (fitting target, fitted part)
P: Orthogonal plane
R: Reference point
S: Socket (fitting part)
S2: Movement step
S3: Detection step
S4: Stop step

1. A fitting method comprising:
a movement step of, by controlling a movement section that moves a fastening and loosening member provided with a fitting part to be fitted to a fitted part which is a fitting target, moving the fitting part closer to the fitted part while moving the fastening and loosening member along an orthogonal plane orthogonal to an axial center of the fitting part; and
a stop step of stopping movement of the fastening and loosening member along the orthogonal plane in a case where the fitting part is fitted to the fitted part.

2. The fitting method according to claim 1, wherein
the movement section includes paired linear actuators that move the fastening and loosening member in two directions parallel to the orthogonal plane and orthogonal to each other, and
in the movement step, the paired linear actuators are controlled to move the fastening and loosening member along the orthogonal plane.

3. The fitting method according to claim 1, wherein in the movement step, the movement section moves the fastening and loosening member along the orthogonal plane after aligning the axial center of the fitting part with a reference point corresponding to a position of an axial center of the fitted part.

4. The fitting method according to claim 1, further comprising a detection step of, after the movement step has started, detecting that the fitting part has been fitted to the fitted part.

5. The fitting method according to claim 4, wherein
in the movement step, the fitting part is moved closer to the fitted part while rotating the fitting part about the axial center of the fitting part, and
in the detection step, a change in a rotational torque of the fitting part is detected.

6. A fitting device comprising:
a fastening and loosening member provided with a fitting part to be fitted to a fitted part which is a fitting target; and
a movement section that moves the fastening and loosening member,
the movement section being configured to
move the fitting part closer to the fitted part while moving the fastening and loosening member along an orthogonal plane orthogonal to an axial center of the fitting part and
stop movement of the fastening and loosening member along the orthogonal plane in a case where the fitting part is fitted to the fitted part.
